(19) United States
(12) Patent Application Publication
(10) Pub. No.: US 2026/0054796 A1
(43) Pub. Date: Feb. 26, 2026

(54) Personal Vehicle

(71) Applicant: KELVIN STRINGER, PERTH (AU)

(72) Inventor: KELVIN STRINGER, PERTH (AU)

(21) Appl. No.: 19/259,292

(22) Filed: Jul. 3, 2025

Related U.S. Application Data
(60) Provisional application No. 63/685,345, filed on Aug. 21, 2024.

(51) Int. Cl. B62M 1/00; B62K 19/00

(52) U.S. Cl. CPC B62M 1/00; B62K 19/00

(57) ABSTRACT

A manually-powered personal stand-on vehicle having a deck for a rider to stand on, a frame, multiple ground engaging wheels, and a drive mechanism providing power to at least one of the wheels to propel the vehicle. The deck may include a portion connected to the frame by a pivot, thereby providing a pivot axis which enables a pivoting motion of at least a portion of the deck relative to the frame. The drive mechanism is integrated with the deck such that when downward force is applied by the rider onto a portion of the deck which is upwardly angled relative to the frame in a manner which causes the portion of the deck to pivot downwards toward the frame, the drive mechanism is actuated to power at least one of the wheels for forward propulsion.

### CROSS-REFERENCE TO RELATED APPLICATIONS

This application claims the benefit of and incorporates by reference co-pending U.S. provisional patent application Ser. No. 63/685,345 filed Aug. 21, 2024.

### BACKGROUND OF THE INVENTION

### Field of the Invention

This disclosure relates generally to personal stand-on vehicles and, more particularly, to a personal stand-on vehicle having a human power propulsion system.

### Description of the Prior Art

The design and use of personal stand-on vehicles, such as skateboards and scooters for recreational, training, and/or sports use, is well established. While in modern times it is not uncommon for such vehicles to utilize motor/engine driven mechanisms for propulsion, traditionally, such vehicles have often been designed and structured to be propelled through human power. In this regard, when using human power, such vehicles generally rely on manual action and/or gravity to propel the vehicle in a desired direction. For example, in the case of a skateboard or scooter that is propelled through human (and/or manual) power, a rider who is standing on a deck (or platform) of the skateboard or scooter would typically take one of their feet off of the deck (possibly temporarily) in order to push against the ground, with this pushing against the ground creating the force that can propel the vehicle and rider in the desired direction.

Manually powered skateboards have previously been proposed, such as disclosed in United States patent documents U.S. Pat. Nos. 4,595,209 and 4,861,054, and United Kingdom patent document GB 2158401. The aforementioned manually-powered skateboards utilize a pedal-operated drive mechanism, where the rider applies foot pressure to a pedal mounted on or above the deck of the skateboard to operate a chain or belt-operated drive mechanism to power one or more wheels for propulsion.

A manually-powered treadle-operated scooter is disclosed in United Kingdom patent document GB 2504447. That document discloses a treadle-operated manually-powered scooter. A pedal is pivoted by a lever arm to a platform of the scooter. The opposite end of the lever arm is connected on an opposite side of the pivot to a chain. The chain drives one or more cogs providing drive to the wheels. A spring returns the chain, lever arm, and pedal when the pedal is released.

Nonetheless, a limitation in typical pedal-powered skateboards and scooters is that the pedal and pivot mechanism takes up space on the deck, reducing comfortable standing space. Often, the pedal and/or part of the drive mechanism protrudes through or is mounted onto the top of the deck, reducing the surface area of smooth standing space and creating uneven footing for the rider. Such uneven footing is not only uncomfortable for the rider, but also risks unbalancing the rider or causing a fall from the deck.

A lack of space can further manifest in creating another limitation that relates to a pedal or treadle of such devices being relatively short in length and having a corresponding short distance from their respective pivot axis to the distal end of the pedal/treadle. This results in short pedal/treadle power strokes when a rider is imparting power to the skateboard/scooter and, therefore, correspondingly short power application time to the skateboard/scooter. Consequently, a rider may have to vigorously and continually keep pedaling/treadling to maintain any reasonable forward momentum and relatively little power can be applied in any one power stroke of the pedal/treadle. This limits the force and, therefore, the power applied in each power stroke and, thus, limits the speed of the skateboard or scooter.

In addition, the deck of many known manually-powered skateboards and scooters is relatively flat, generally extending along a plane extending between the front and rear wheels, and the pedal/treadle is mounted to or within the deck or close thereto. Riders can find such relatively flat decks or platforms do not provide a comfortable stance position and can compromise stability and the rider's ability to control, steer, and/or perform agility maneuvers.

Thus, there remains a need for a manually-powered personal stand-on vehicle for sport, training, and/or recreation that provides alternative drive and/or rider stance options compared with conventional manually-powered skateboards and scooters. It would be desirable for such a manually-powered personal stand-on vehicle to position its pedal or pivot mechanism in a location that does not take up space on its deck. It would additionally be desirable for such a manually-powered personal stand-on vehicle to arrange its pedal or pivot mechanism in a manner that allows for relatively long manual strokes when a rider is imparting power to the vehicle.

### SUMMARY OF THE INVENTION

The present disclosure provides for a personal stand-on vehicle, comprising: an elongated, rigid frame having a pivot mount; at least one front wheel integral with the frame; at least one rear wheel integral with the frame; an elongated deck member having at least a front portion and a rear portion, wherein the deck member includes a pivot positioned between the front portion and rear portion and integrated with the pivot mount at a pivot axis such that the deck member selectively pivots about the pivot axis, moving between a base position and a driven position in response to an application of force by a user on the deck member; wherein in the base position, the front portion is closer to the frame than the rear portion and in the driven position, the front portion is further from the frame than when it was in the base position and the rear portion is closer to the frame than when it was in the base position; and a drivetrain integral with the deck member and the at least one rear wheel, wherein the drivetrain is configured to transfer force applied by the user to cause the deck member to pivot from the base position to the driven position to the at least one rear wheel in a manner that causes the at least one rear wheel to rotate.

It is an object of the present disclosure to provide a manually-powered personal stand-on vehicle for one or more of sport, training, and recreation that provides alternative drive and/or rider stance options compared with conventional manually-powered skateboards and scooters.

It is an additional object of the present disclosure to provide a manually-powered personal stand-on vehicle that positions its pedal or pivot mechanism in a location that does not take up space on its deck.

It is yet another object of the present disclosure to provide a manually-powered personal stand-on vehicle that arranges its pedal or pivot mechanism in a manner that allows for relatively long manual strokes when a rider is imparting power to the vehicle.

### BRIEF DESCRIPTION OF THE DRAWINGS

FIG. 1 shows a front perspective view of a personal stand-on vehicle built in accordance with an embodiment of the present disclosure, shown with a rider thereon.

FIG. 2 shows a side elevational view of a personal stand-on vehicle built in accordance with an embodiment of the present disclosure.

FIG. 3 shows a top plan view of a frame, wheels, and steering arrangement of a personal stand-on vehicle built in accordance with an embodiment of the present disclosure.

FIG. 4 shows a side elevational view of a frame of a personal stand-on vehicle built in accordance with an embodiment of the present disclosure.

FIG. 5 shows a sectional plan view of a drive transfer means of a personal stand-on vehicle built in accordance with an embodiment of the present disclosure.

FIG. 6 shows a side elevational view of a deck frame of a personal stand-on vehicle built in accordance with an embodiment of the present disclosure.

FIG. 7 shows a top plan view of a deck frame of a personal stand-on vehicle built in accordance with an embodiment of the present disclosure.

FIG. 8 shows a sectional plan view of a pivot of a drive transfer means of a personal stand-on vehicle built in accordance with an embodiment of the present disclosure.

FIG. 9 shows a top plan view of a steering mechanism with front wheels of a personal stand-on vehicle built in accordance with an embodiment of the present disclosure.

FIG. 10 shows a deck of a personal stand-on vehicle built in accordance with an embodiment of the present disclosure, showing the drive function thereof with the deck in its base position prior to a downward power stroke.

FIG. 11 shows a deck of a personal stand-on vehicle built in accordance with an embodiment of the present disclosure, showing the drive function thereof with the deck in its driven position after delivery of the downward power stroke.

FIG. 12 shows a side elevational view of a drivetrain of a personal stand-on vehicle built in accordance with an alternate embodiment of the present disclosure.

FIG. 13 shows a top plan view of a drivetrain of a personal stand-on vehicle built in accordance with an alternate embodiment of the present disclosure.

FIG. 14 shows a side elevational view of a drive mechanism of a personal stand-on vehicle built in accordance with an alternate embodiment of the present disclosure.

FIG. 15 shows a top plan view of a drive mechanism of a personal stand-on vehicle built in accordance with an alternate embodiment of the present disclosure.

FIG. 16 shows a front left perspective view of a personal stand-on vehicle built in accordance with an embodiment of the present disclosure.

FIG. 17 shows a front right perspective view of a personal stand-on vehicle built in accordance with an embodiment of the present disclosure.

### DETAILED DESCRIPTION OF THE INVENTION

Described herein is a manually-powered personal stand-on vehicle having a deck for a rider to stand on, a frame, multiple ground engaging wheels, and a drive mechanism providing power to at least one of the wheels to propel the vehicle. The deck may include a portion connected to the frame by a pivot, thereby providing a pivot axis which enables a pivoting motion of at least a portion of the deck relative to the frame. The drive mechanism is integrated with the deck such that when downward force is applied by the rider onto a portion of the deck which is upwardly angled relative to the frame in a manner that causes the portion of the deck to pivot downwards toward the frame, the drive mechanism is actuated to power at least one of the wheels for forward propulsion.

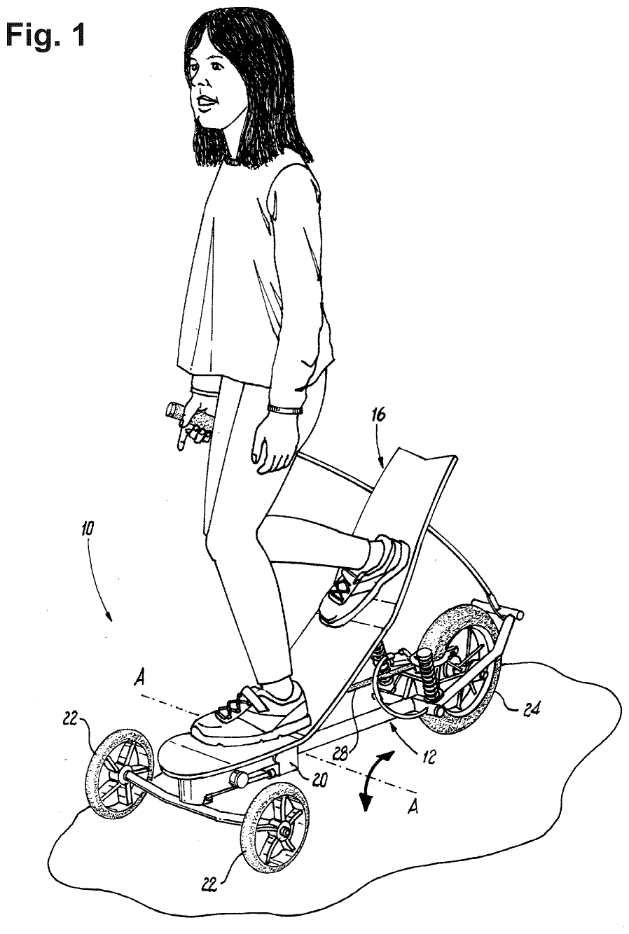

Referring now to the drawings and, in particular, FIGS. 1-11, 16, and 17, a manually-powered personal stand-on vehicle 10 is shown having a main frame 12, a deck frame 14, and a deck platform 16. The deck frame 14 may include a pivot 18 having a pivot axis A-A which mounts to a bracket 20 on the main frame 12, thereby enabling the deck frame 14 and attached deck platform 16 to pivot relative to the main frame 12. Together, the deck frame 14 and the deck platform 16 may be referred to herein as the deck.

The deck may be pivoted to rock about the pivot axis A-A. In this regard, the pivot axis A-A may be aligned transversely relative to a longitudinal axis of the personal vehicle 10, such that the rocking action is forward to rearward, and vice versa. The rocking action may be controlled by the rider, as described below, and the propulsion through the drive mechanism is provided by at least a downward motion of a portion of the deck during the rocking action.

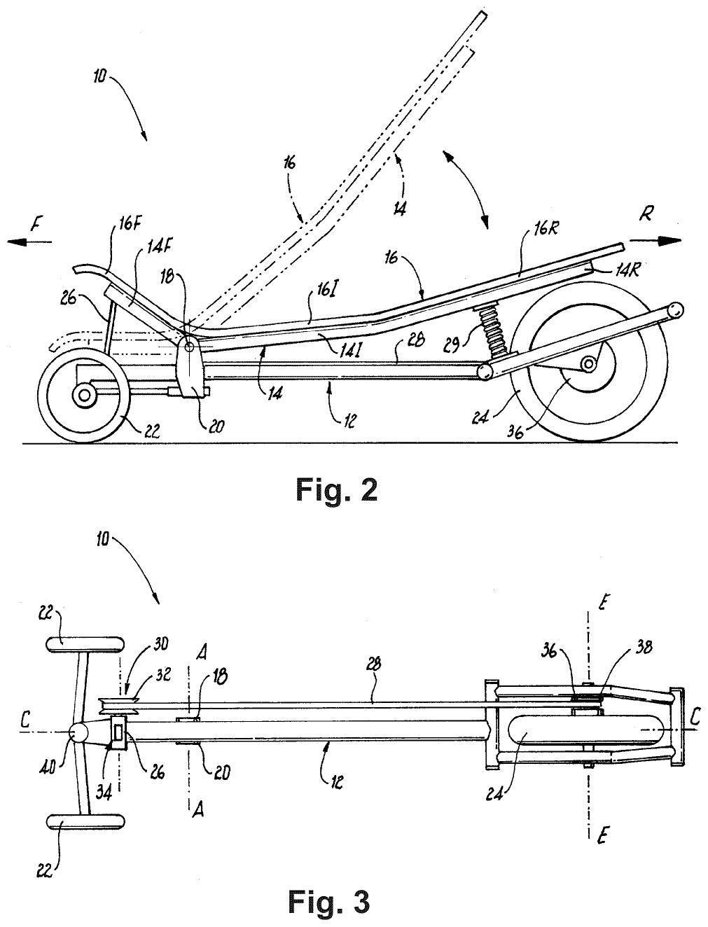

As illustrated in FIG. 2, the deck platform 16 may include a deck platform front portion 16F forward (F) of the pivot 18, as well as a deck platform intermediate portion 16I and a deck platform rear portion 16R rearward (R) of the pivot 18. Similarly, the deck frame 14 may include a deck frame front portion 14F forward (F) of the pivot 18, as well as a deck frame intermediate portion 14I and a deck frame rear portion 14R rearward (R) of the pivot. As illustrated in FIG. 7, the deck frame 14 may bifurcate at the deck frame rear portion 14R.

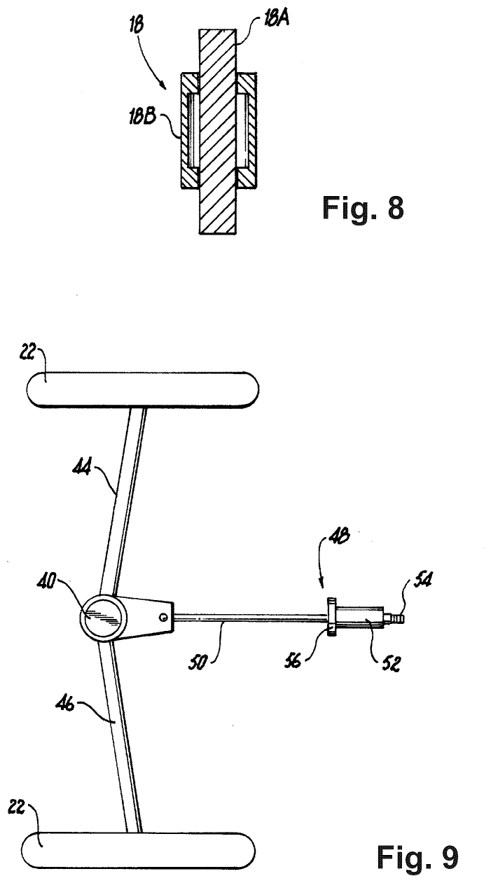

In addition, the pivot 18 may include a deck pivot shaft 18A and deck pivot body 18B, as illustrated in FIG. 8.

A first drive means 26 may be connected between the deck frame front portion 14F and a first drive transfer means 30. The first drive means 26 may be a flexible belt, such as of rubber or carbon reinforced material (such as Kevlar), or a belt made from combinations of such materials or similar materials. The first drive means 26 may be toothed to enable it to engage with a toothed drive axle 34 (or splined shaft or wheel) of the first drive transfer means 30 for additional drive transfer/friction. In this regard, the first drive means 26 may alternatively be a chain arranged to engage with teeth of the first drive transfer means 30. The first drive transfer means 30 may include a pulley 32 connected with and arranged to rotate with the drive axle 34 (or splined shaft or wheel), all aligned on a first drive transfer means axis D-D.

A second drive means 28 conveys drive from the first drive transfer means 30 to a second drive transfer means 36 from which the rear wheel 24 is driven. The second drive transfer means 36 includes a clutch mechanism 38 (or other one-way drive arrangement) such that the rear wheel 24 is driven about a rear drive axis E-E by the second drive means 28 to rotate the rear wheel 24 and to propel the personal vehicle 10 forward when the intermediate and rear deck portions 16I, 16R, 14I, and 14R are forced downward, but is undriven, allowing the rear wheel 24 to freewheel as the intermediate and rear deck portions 16I, 16R, 14I, and 14R return upwards.

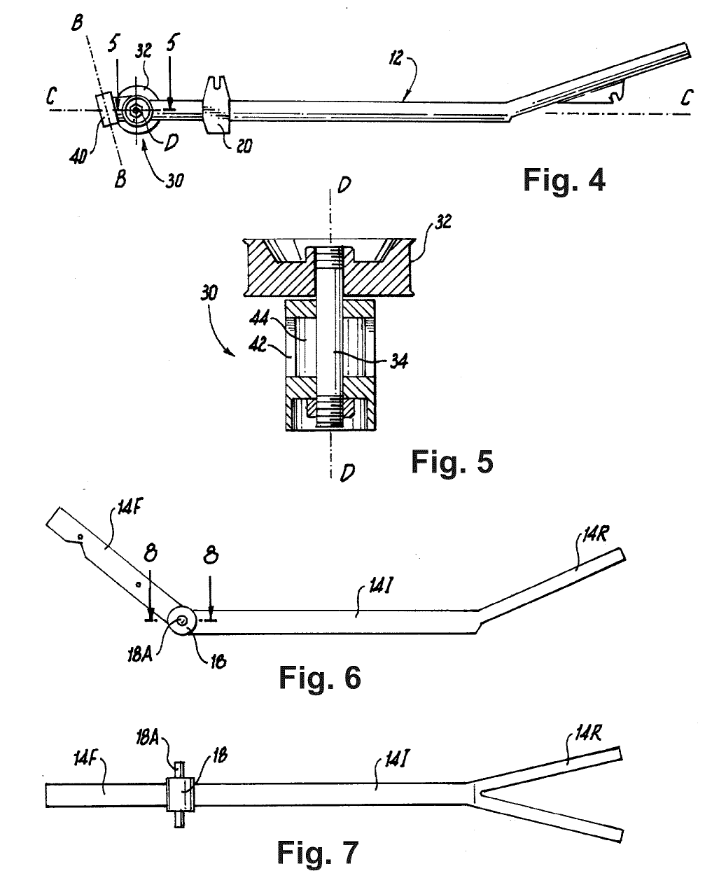

The personal vehicle 10 includes front wheels 22, which may be laterally connected together by a beam 46 that is integrated with a steering bearing 40 having a bearing axis B-B angled from vertical in the side view plane (see FIG. 4) and enabling lean steer to turn the front wheels 22 and beam 46 based on shifting of the rider's weight/center of mass relative to a longitudinal centerline C-C of the personal vehicle 10 passing through the bearing 40.

As illustrated in FIG. 3, laterally spaced front wheels 22 are connected via a steering mechanism (described later) to the main frame 12 and a single rear wheel 24 is connected to a rear portion of the main frame 12. In the preferred embodiment, the front wheels 22 are constructed of a plastic or polyurethane material, and the rear wheel 24 is a pneumatic wheel.

It is contemplated that embodiments of the personal vehicle may include multiple rear wheels, such as laterally spaced rear wheels, preferably on a fixed axle or connected to a lean steer axle arrangement, such as in a standard skateboard or a version of the front steering mechanism described later herein. In some embodiments, at least one rear wheel 24 may be fitted with a fender (not shown in the drawings) that partially surrounds the rear wheel 24 and is located a distance from the outer surface of the rear wheel. The fender may be mounted to the main frame 12 or other element of the personal vehicle and may be configured to block the deck or the rider's foot from contacting the rear wheel when the deck is lowered into it's driven position, as well as to block debris on the ground from being thrown up at the rider by the rotating rear wheel.

As illustrated in the figures, the first drive transfer means 30 may include a drive axle 34 arranged to drive a second drive means 28 (such as a flexible belt or chain). The drive axle 34 may be held in a bearing body 40.

An aperture 42 provides an opening for the first drive means 26 to extend therethrough and connect to the deck frame front portion 14F. It will be appreciated, therefore, that the first drive means 26 may provide balance by being operative through the longitudinal centerline C-C of the personal vehicle.

The steering mechanism 44, as illustrated in FIG. 9, may include the steering bearing 40 and beam 46 connecting the laterally spaced front wheels 22. A steering adjustment mechanism 48 may include a link arm 50 extending to a steering adjuster resilient means 52 and adjustment means 54. The adjustment means 54 may include an adjustment nut on a threaded end of the link arm 50 which compresses or relaxes the steering adjuster resilient means 52 associated with a cleat/housing 56.

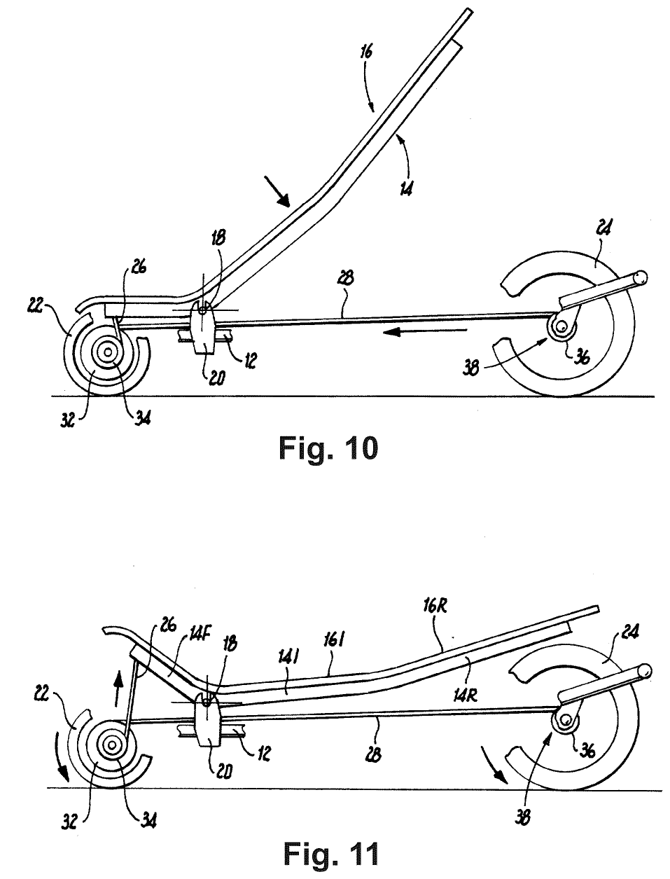

The manner in which the drivetrain functions to transfer driveforce/power from the rider to the drive wheel(s) is illustrated in FIGS. 10 and 11. In a base position, as shown in FIG. 10, the deck 14 may be raised. A rider may stand on the deck with a stance having one foot on the front portions 14F and 16F of the deck ahead of the pivot 18 and a second foot rearward thereof on the intermediate portions 14I and 16I or, preferably for application of greater downward force over a longer effective lever of the deck, the rear portions 14R and 16R. The rider may then exert mechanical force manually through their second foot on the deck rearward of the pivot 18, moving the deck to a driven position as illustrated in FIG. 11. This application of force causes the front portions 14F and 16F to angle upwards, pulling on the first drive means 26 attached thereto. The first drive means 26 unwraps from around the drive axle 34 of the first drive transfer means 30, causing the larger pulley 32 to rotate and providing a drive ratio (gearing) variation. In this regard, the first drive means 26 rotates the first drive transfer means pulley 32, which acts on the second drive means 28 to rotate the second drive transfer means 36, thereby rotating the rear wheel 24.

The second drive transfer means 36 may include a one-way drive device (such as a ratchet mechanism) and a return biasing means such that, after the power stroke when the deck is in the driven position shown in FIG. 11 (or a position partway between the fully raised base position in FIG. 10 and the fully lowered driven position in FIG. 11), the return biasing means and the one-way drive device return the second drive transfer means 36, the second drive means 28, the first drive transfer means 30, and the first drive means 26 back to their prior position (i.e., a “ready for a power stroke” position) with the deck returned to the raised base position.

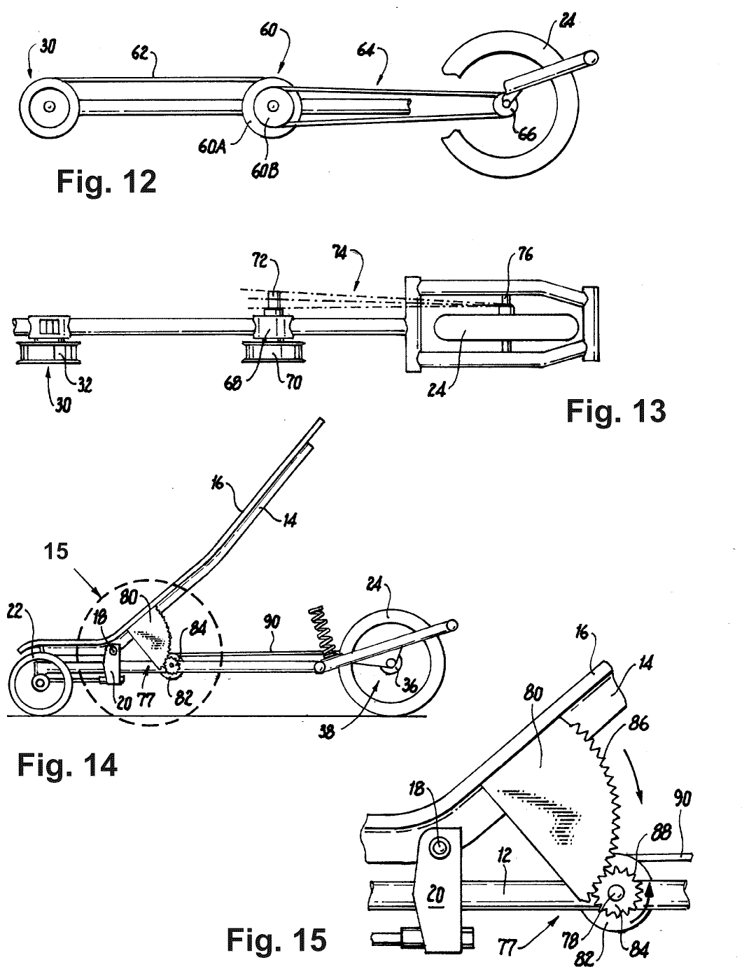

Referring now to FIGS. 12 and 13, embodiments of a personal vehicle may include an alternate drivetrain arrangement. One such arrangement may include a first intermediate drive transfer means 60 including an input pulley 60A and an output pulley 60B.

In such an arrangement, a forward drive means 62 conveys drive from the first drive transfer means 30 to the first intermediate drive transfer means input pulley 60A. The output pulley 60B is connected to the input pulley 60A via a shaft. Rotation of the input pulley 60A causes rotation of the output pulley 60B, which in turn transfers drive to the rear drive means 64. The rear drive means 64 provides drive to the rear drive transfer means 66 adjacent the rear wheel 24. The rear drive transfer means 66 rotates a pulley adjacent to the rear wheel 24, and can be a continuous drive belt.

One-way (forward) drive can be provided by the first intermediate drive transfer means 60 or by the rear drive transfer means 66. The first intermediate drive transfer means 60 may include a return biasing means to return the forward drive means 62, the first drive transfer means 30, and the first drive means (not shown) to a position ready for a further power stroke.

A second intermediate drive transfer means 68 may include an input pulley 70 that rotationally drives a gear set 72 providing selectable drive/gear ratios, which provide a variable output ratio to a rear drive means 74 (shown in dotted lines in a range of positions across the selectable gears and driving the rear wheel via rear drive gear 76).

Referring now to FIGS. 14 and 15, embodiments of a personal vehicle may include an alternative drive mechanism. In such embodiments, instead of a first drive transfer means forward of the deck pivot 18, the geared drive transfer means is provided rearward of the deck pivot. The intermediate and rearward portions of the deck may, however, still pivot up and down as described above to provide propulsion through the drive mechanism to the drive wheel(s).

A geared drive transfer means 77 may include a drive gear 80 in the form of an arcuate/curved toothed gear section attached to the deck, preferably arcuate at a radius from the center of the deck pivot 18. Teeth 86 of the drive gear 80 engage with corresponding teeth 88 of a driven gear 84 rotationally mounted to the main frame 12 by a pivot 78. Forward movement of the intermediate and rear portions of the deck cause the drive gear 80 to rotate the driven gear 84, which driven gear rotates and correspondingly causes the output pulley 60B or gear 82 to rotate, which drives a geared drive transfer means actuated drive means 90 to drive the rear drive transfer means and the rear wheel.

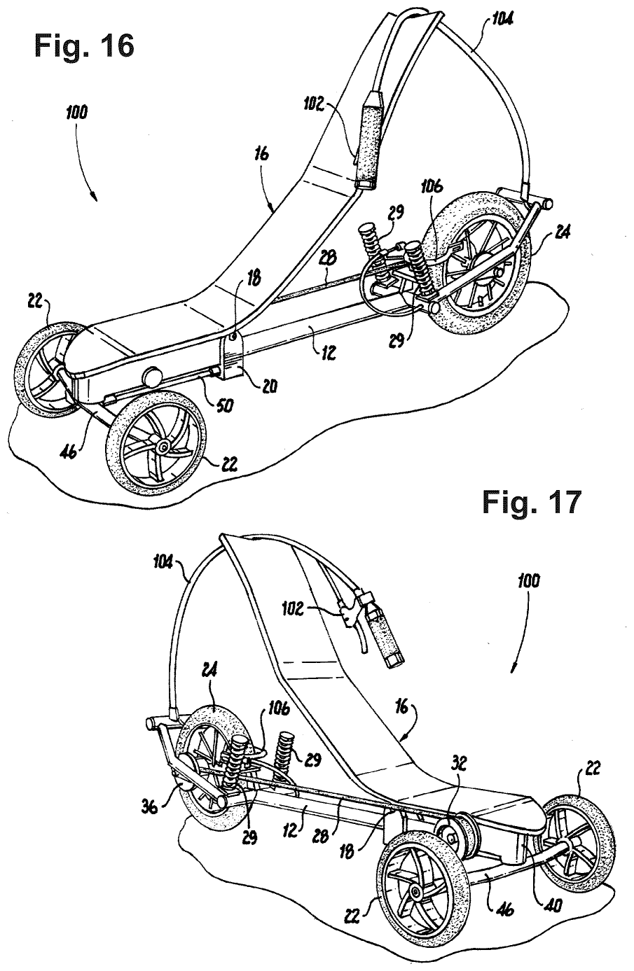

Referring now to FIGS. 16 and 17, a personal vehicle 100 according to an embodiment of the present disclosure may provide a brake control 102 connected via a flexible cable 104 to a brake mechanism 106 at the rear wheel. In this regard, the braking and/or drive ratio variation/gear ratio may be controlled by the brake control 102, which may be defined as a cable 104 connected controller having a brake control and/or a drive ratio/gear change control. Braking can be affected by a brake mechanism operating on the rear wheel and/or on one or more other wheels. The brake control 102 further serves as handle for the rider to hold during use of the personal vehicle 100 so as to assist the rider in maintaining balance.

It will be appreciated that the deck platform 16 can be a one-piece deck. The deck may be of molded and/or shaped wood, plastic, or metal, or a combination of two or more thereof. The deck may preferably be of molded ply/laminated timber, such as a one-piece steam/heat-shaped deck.

Substantially all of the deck may provide a pedal. For example, the deck may be pivoted partway along its length such that, as a portion of the deck to one side of the pivot 18 moves upward or downward, the portion of the deck on the opposite side of the pivot 18 moves in the respective opposite downward or upward direction.

Alternatively, a portion of the deck may not form a portion of the pedal. For example, a forward portion of the deck may be attached to the main frame 12 of the personal vehicle, either attached rigidly or utilizing a suspension/cushion, such as a rubber or elastomer bushing or a springing mechanism, or other resilient means.

In embodiments of the personal vehicle disclosed herein, the deck may be pivoted partway between forward and rearward ends thereof, providing a rider with opportunity for a stance having a first foot position forward of the pivot 18 and a second foot position rearward of the pivot 18 with respect to a forward direction of travel or intended travel.

In addition, at least a portion of the deck may angle upward. For example, at least a portion of the deck may be curved, flat, or a combination of curved and flat portions. The portion that angles and/or is curved upward may be the aspect of the deck rearward of the pivot 18, such that a rider applying a downward force to the upwardly angled portion causes the angled portion to move downward toward the ground.

It is appreciated that downward movement of the rearward deck portion may operate the drive mechanism to apply a drive force to one or more wheels, providing forward propulsion of the vehicle. For example, the portion of the deck forward of the pivot 18 may pivot upwards as the rearward portion pivots downward during forward propulsion of the vehicle. As described above, the forward portion of the deck may be connected to at least one drive means of the drive mechanism, such as a drive belt or chain.

It will be appreciated that the forward and rearward portions of the deck and their relationship to operation of the drive mechanism may be such that downward movement of the rearward portion and upward movement of the forward portion relative to the deck to frame pivot arising from force applied by the rider (to the rearward portion) may operate the drive mechanism and provide forward propulsion. In addition, it is contemplated that forward propulsion of the vehicle may only be generated through the drive mechanism when the deck rotates about the pivot 18 in one direction, while rotation of the deck in the counter direction provides a freewheeling effect through the drive mechanism as the drive mechanism is reset and rendered ready for further forward propulsion action.

In embodiments of the personal vehicle disclosed herein, the drive means may be connected to an underside of a portion of the deck. Furthermore, in various embodiments, the drive means may drive the front wheel or wheels, or the rear wheel or wheels, and the drive mechanism may include the provision of drive from the front or rear wheel or wheels to the other of the rear or front wheel or wheels.

It is contemplated that, in embodiments of the personal vehicle disclosed herein, the drive mechanism may include a one-way drive device, such as a clutch or ratchet, configured to provide a driving force for propulsion of the personal vehicle in a forward direction and no driving force (freewheeling) while the drive mechanism is resetting. For example, as a rearward portion of the deck is pivoted downward by a rider, the drive device is engaged and powers the wheel or wheels. As the deck's rearward portion pivots upward, the drive device disengages and does not drive the wheel or wheels. A similar drive arrangement may be provided relative to movement of the forward portion of the deck when the forward portion moves downward.

In embodiments of the personal vehicle disclosed herein, two drive devices may be provided. For example, one drive device may engage when the rearward portion of the deck is forced downward while the second drive device is disengaged, and the second drive device may engage as the rearward portion of the deck moves upward while the first drive device is disengaged. In this manner, forward propulsion may be provided during both downward and upward movement of the relevant deck portion.

In embodiments of the personal vehicle disclosed herein, the pivot may include a pivot axis, such as an axle or stub axles, supported by one or more bearings or sleeve mounts attached to a bracket arrangement. The bracket arrangement may also support a mount for a portion of a steering mechanism 44.

In embodiments of the personal vehicle disclosed herein, the steering mechanism 44 may include a steering damper or limiter, such as at least one resilient means (e.g. a spring, a rubber or urethane elastomeric member or a combination thereof).

In three wheel embodiments of the personal vehicle disclosed herein, there may be two forward wheels and one rearward wheel, or vice versa. When two forward wheels are employed, the two forward wheels may be laterally spaced. In addition, the two laterally spaced wheels may be steerable via an integrated steering mechanism such as that described above. With such a steering mechanism, steering may be accomplished through the rider leaning, whereby the rider shifting their center of mass laterally from being centered over the deck causes lean or turn of the forward wheels and thereby turning of the personal vehicle.

In embodiments of the personal vehicle disclosed herein, the steering mechanism may include a beam axle mounted to a portion of the frame by a bearing and pivot, such as an angled pivot. In such embodiments, steering of the personal vehicle may be affected by merely applying a greater proportion of the rider's weight to one lateral side of the deck compared to the other side of the deck across a longitudinal centerline thereof. The angled pivot of the steering mechanism may then bias steering toward one of a left or right direction based on the applied greater proportion of weight.

In embodiments of the personal vehicle disclosed herein, the drive means may include a first drive means connected between the deck and a first drive transfer means, and a second drive means connected between the first drive transfer means and the drive device. The first drive transfer means may provide gearing, such as a variation on pulley diameter between a first drive pulley or gear driven by the first drive means and a second drive pulley or gear providing drive to the second drive means. In this regard, the first drive transfer means may include gearing, such as continuously variable gearing (e.g. one or more variable diameter pulleys), or may include toothed gearing for discrete selective gears, or a combination thereof, such as toothed gearing or a variable diameter pulley or cone drive associated with drive imparted by the first drive means to the first drive transfer means, and toothed gearing or a variable diameter pulley or cone drive associated with drive imparted by the drive transfer means to the wheel or wheels (which drive may be via other gearing or a drive clutch etc.)

In embodiments with gearing of the personal vehicle disclosed herein, the first drive pulley or gear is of smaller diameter than the second drive gear or pulley. In addition, a drive ratio variation means may be provided, such as continuously variable or selective ratio gearing.

In embodiments of the personal vehicle disclosed herein, the personal vehicle may include one or multiple pivot movement limiters for the deck, such as one or more stops that limit the maximum downward travel of a portion of the deck. The pivot movement limiters may include at least one resilient means, such as one or more springs, rubber stops, urethane stops, or a combination of two or more thereof. Such pivot movement limiter may be mounted to the frame of the personal vehicle or may be mounted to the deck, or a combination thereof.

In embodiments of the personal vehicle disclosed herein, the drive ratio variation/gear change may be affected by one of the drive transfer means including drive ratio variation/gear change means. For example, one or more of the drive transfer means may include a variable diameter pulley, a selectable gear set having differing ratios/sizes (e.g. a number of selectable gear cogs of different sizes), a cone drive providing at least one variable diameter pulley for drive ration variation, or a combination of two or more thereof.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A personal vehicle for use by a standing user, comprising:
an elongated, rigid frame having a pivot mount;
at least one front wheel integral with the frame;
at least one rear wheel integral with the frame;
an elongated deck member having at least a front portion and a rear portion, wherein the deck member includes a pivot which is integrated with the pivot mount at a pivot axis such that the deck member selectively pivots about the pivot axis, moving between a base position and a driven position in response to an application of force by a user on the deck member;
wherein in the base position, the front portion is closer to the frame than the rear portion and in the driven position, the front portion is further from the frame than when it was in the base position and the rear portion is closer to the frame than when it was in the base position; and
a drivetrain integral with the deck member and at least one of the at least one front wheel and the at least one rear wheel, wherein the drivetrain is configured to transfer force applied by the user to cause the deck member to pivot from the base position to the driven position to at least one of the at least one front wheel and the at least one rear wheel in a manner which causes the at least one of the at least one front wheel and the at least one rear wheel to rotate.

2. The personal vehicle for use by a standing user of claim 1, wherein the pivot is positioned between the front portion and rear portion.

3. The personal vehicle for use by a standing user of claim 2, wherein the front portion has a planar top surface and is oriented such that when the deck member is in the driven position, the front portion slopes upwards and away from the frame moving towards an edge of the front portion furthest from the rear portion.

4. The personal vehicle for use by a standing user of claim 2, wherein the rear portion has a planar top surface and is oriented such that when the deck member is in the driven position, the rear portion slopes upwards and away from the frame moving towards an edge of the rear portion furthest from the front portion.

5. The personal vehicle for use by a standing user of claim 1, wherein the deck member includes an intermediate portion positioned between the front portion and the rear portion.

6. The personal vehicle for use by a standing user of claim 5, wherein the pivot is positioned between the front portion and intermediate portion.

7. The personal vehicle for use by a standing user of claim 6, wherein the front portion and the intermediate portion both have planar top surfaces, with the front portion and the intermediate portion oriented such that the top surface of the front portion and the top surface of the intermediate portion form an obtuse angle and when the deck member is in the driven position, the front portion slopes upwards and away from the frame moving towards an edge of the front portion furthest from the intermediate portion.

8. The personal vehicle for use by a standing user of claim 6, wherein the rear portion and the intermediate portion both have planar top surfaces, with the rear portion and the intermediate portion oriented such that the top surface of the rear portion and the top surface of the intermediate portion form an obtuse angle and when the deck member is in the driven position, the rear portion slopes upwards and away from the frame moving towards an edge of the rear portion furthest from the intermediate portion.

9. The personal vehicle for use by a standing user of claim 1, wherein the pivot mount is defined by a bracket.

10. A personal vehicle for use by a standing user, comprising:
an elongated, rigid frame having a pivot mount;
at least one front wheel integral with the frame;
at least one rear wheel integral with the frame;
an elongated deck member having at least a front portion and a rear portion, wherein the deck member includes a pivot positioned between the front portion and the rear portion and integrated with the pivot mount at a pivot axis such that the deck member selectively pivots about the pivot axis, moving between a base position and a driven position in response to an application of force by a user on the deck member;
wherein in the base position, the front portion is closer to the frame than the rear portion and in the driven position, the front portion is further from the frame than when it was in the base position and the rear portion is closer to the frame than when it was in the base position; and
a drivetrain integral with the deck member and the at least one rear wheel, wherein the drivetrain is configured to transfer force applied by the user to cause the deck member to pivot from the base position to the driven position to the at least one rear wheel in a manner which causes the at least one rear wheel to rotate.

11. The personal vehicle for use by a standing user of claim 10, wherein the front portion has a planar top surface that is oriented such that when the deck member is in the driven position, the front portion slopes upwards and away from the frame moving towards an edge of the front portion furthest from the rear portion.

12. The personal vehicle for use by a standing user of claim 10, wherein the rear portion has a planar top surface that is oriented such that when the deck member is in the driven position, the rear portion slopes upwards and away from the frame moving towards an edge of the rear portion furthest from the front portion.

13. The personal vehicle for use by a standing user of claim 10, wherein the deck member includes an intermediate portion positioned between the front portion and the rear portion.

14. The personal vehicle for use by a standing user of claim 13, wherein the pivot is positioned between the front portion on one hand, and the rear portion and intermediate portion on the other.

15. The personal vehicle for use by a standing user of claim 14, wherein the front portion and the intermediate portion both have planar top surfaces, with the front portion and the intermediate portion oriented such that the top surface of the front portion and the top surface of the intermediate portion form a first obtuse angle and when the deck member is in the driven position, the front portion slopes upwards and away from the frame moving towards an edge of the front portion furthest from the intermediate portion.

16. The personal vehicle for use by a standing user of claim 15, wherein the rear portion and the intermediate portion both have planar top surfaces, with the rear portion and the intermediate portion oriented such that the top surface of the rear portion and the top surface of the intermediate portion form a second obtuse angle and when the deck member is in the driven position, the rear portion slopes upwards and away from the frame moving towards an edge of the rear portion furthest from the intermediate portion.

17. The personal vehicle for use by a standing user of claim 14, wherein the rear portion and the intermediate portion both have planar top surfaces, with the rear portion and the intermediate portion oriented such that the top surface of the rear portion and the top surface of the intermediate portion form an obtuse angle and when the deck member is in the driven position, the rear portion slopes upwards and away from the frame moving towards an edge of the rear portion furthest from the intermediate portion.

18. The personal vehicle for use by a standing user of claim 10, wherein the pivot mount is defined by a bracket.

19. A personal vehicle for use by a standing user, comprising:
an elongated, rigid frame having a pivot mount defined by a fixed bracket;
at least one front wheel integral with the frame;
at least one rear wheel integral with the frame;
an elongated deck member having a front portion, a rear portion, and an intermediate portion positioned between the front portion and the rear portion, wherein the deck member includes a pivot positioned between the front portion and the intermediate portion and integrated with the pivot mount at a pivot axis such that the deck member selectively pivots about the pivot axis, moving between a base position and a driven position in response to an application of force by a user on the deck member;
wherein in the base position, the front portion is closer to the frame than the rear portion and in the driven position, the front portion is further from the frame than when it was in the base position and the rear portion is closer to the frame than when it was in the base position; and
a drivetrain integral with the deck member and the at least one rear wheel, wherein the drivetrain is configured to transfer force applied by the user to cause the deck member to pivot from the base position to the driven position to the at least one rear wheel in a manner which causes the at least one rear wheel to rotate.

20. The personal vehicle for use by a standing user of claim 19, wherein:
the front portion and the intermediate portion both have planar top surfaces, with the front portion and the intermediate portion oriented such that the top surface of the front portion and the top surface of the intermediate portion form a first obtuse angle and when the deck member is in the driven position, the front portion slopes upwards and away from the frame moving towards an edge of the front portion furthest from the intermediate portion; and
wherein the rear portion and the intermediate portion both have planar top surfaces, with the rear portion and the intermediate portion oriented such that the top surface of the rear portion and the top surface of the intermediate portion form a second obtuse angle and when the deck member is in the driven position, the rear portion slopes upwards and away from the frame moving towards an edge of the rear portion furthest from the intermediate portion.
